(19) United States
(12) Patent Application Publication
(10) Pub. No.: US 2007/0278767 A1
(43) Pub. Date: Dec. 6, 2007

(54) ELECTRICAL WHEELCHAIR FOR HANDICAPPED TRANSPORTATION WITH AN ATTENDANT

(76) Inventor: Jean-Pierre AUBERT, Bogeve (FR)

Correspondence Address: THE MAXHAM FIRM, 9330 SCRANTON ROAD, SUITE 350, SAN DIEGO, CA, 92121, US

(21) Appl. No.: 11/840,495

(22) Filed: Aug. 17, 2007

Related U.S. Application Data
(63) Continuation-in-part of application No. PCT/FR2005/000381, filed on Feb. 17, 2005.

(51) Int. Cl. B60K 1/00

(52) U.S. Cl. 280/642; 180/65.1

(57) ABSTRACT

A foldable electrical wheelchair having speed and braking controls operable by an accompanying person. An H-shaped chassis supports the drive wheels, a motor unit, a shock absorber, an adjustable footrest, and a battery, and provides a low center of gravity. Arms are connected to the chassis which support the seat, back, armrests, and controls selectively in an operable, locked position, while enabling the wheelchair to be folded for storage or transportation in the trunk or body of a motor vehicle.

### FIELD OF THE INVENTION

This invention relates generally to an electrical wheelchair designed for transporting handicapped people with the assistance of an attendant, and more particularly, the wheelchair is entirely foldable and unfoldable without tools, it can be carried or stored with ease, it is provided with an articulate frame, and it includes a shock absorber system.

### DISCUSSION OF PRIOR ART

Known prior art include electrical wheelchairs for transporting handicapped people with an attendant, such wheelchairs being minimally foldable or not foldable at all. These chairs are typically cumbersome, heavy, and have no shock absorber system. They are hardly portable and, besides being complex, are expensive.

### SUMMARY OF THE INVENTION

The electrical wheelchair of embodiments of this invention is different from other electrical wheelchairs in that it has an articulate, simple, and entirely foldable structure. Its basis is an H-shaped chassis, provided for receiving two casters in the front, a retractable and adjustable footrest, a small battery in the middle, a motor block in the rear for an oscillating motor, and a shock absorber. The upper part of the chassis, which supports the seat, is held by two oblique lift links holding the main load with an upper frame comprising locking elements, and control handles are located at the extremity of this frame.

The wheelchair in accordance with an embodiment of the invention easily folds and stores, for example, in the trunk of a vehicle. It also offers a solid structure not degraded by repeated foldings and unfoldings. It is capable of supporting heavy loads. Its balance and its stability are optimum because the chassis offers a very low center of gravity. Therefore, it fills an unfulfilled need in the existing domain of wheelchairs for the transportation of handicapped people or people with reduced mobility.

### BRIEF DESCRIPTION OF THE DRAWING

The objects, advantages, and features of the invention will become more clear with reference to the following detailed description, when read in conjunction with the accompanying drawing, in which:

FIG. 1 is a perspective view of a wheelchair constructed in accordance with the present invention;

FIG. 2 shows the wheelchair of FIG. 1 in a partially folded condition; and

FIG. 3 shows the wheelchair of FIG. 1 in a fully folded condition.

### DETAILED DESCRIPTION OF THE PREFERRED EMBODIMENTS

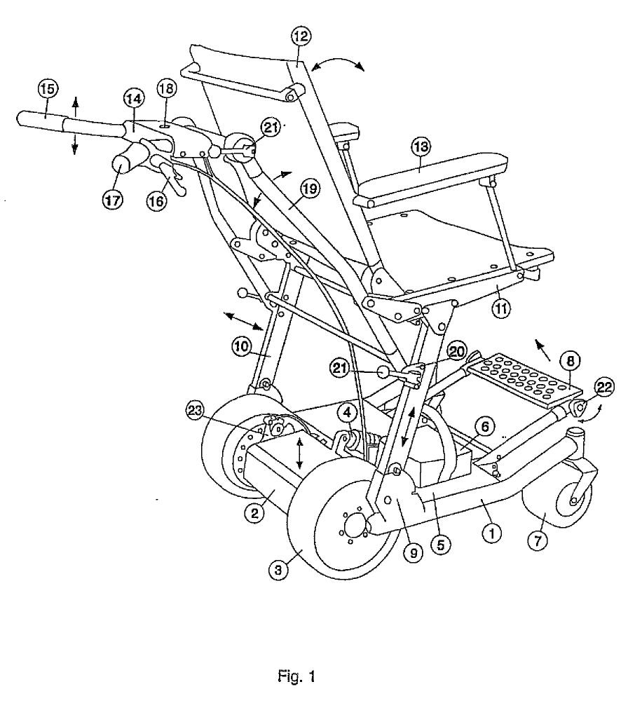

Referring now to the drawing, and more particularly to FIG. 1, H-shaped frame 1 constitutes the main chassis of the assembly. It supports oscillating electrical motor block 2 and drive wheels 3 which are regulated by shock absorber 4, plate 5 which supports small battery 6, casters 7, and footrest 8.

On both sides of frame 1, brackets 9 support an intermediate part comprising lift links 10 articulated in brackets 9. Locking both links 10 in oblique position automatically take place when they are expanded into a backstop, and by a downward pushing action. Conversely, reverse movements are employed for freeing the links. The lift links support seat assembly or foundation 11 that is shifted forward, adjustable back 12, and two armrests 13. Two arms 19 ensure the horizontal position of seat assembly 11. Locking both arms 19 is done by cam locking system 21 that grabs in hook-shaped brackets 20. Control panel 14 is placed at the other upper extremity of arms 19, including two handles 15, brake 16, and accelerator-variator 17. On the top of the control panel is battery discharge warning light 18. Inside of housing 14 there is part of the electronics and the safety braking system (not shown) provided in case of misuse. The whole control panel 14 is articulated for adjusting the height, according to the attendant's size. Cam locking system 21 is used for locking the wheelchair in a selected position.

Indicated by the arrows in the vicinity of back 12 and footrest 8, the possibilities for adjusting the slope of the back 12 and the slant of the footrest 8 are provided for.

The wheelchair driving power is provided by an electrical motor, inside block 2, controlled by electronics coupled to a speed reducing box (not shown). At the box output, a direct drive shaft drives both driving wheels 3, which have large, flexible, and adhesive tires absorbing the imperfections of the ground and making it possible to drive anywhere. Inside wheels 3, a differential (not shown) allows an easy 360° rotation of the wheelchair. Plate 5 on frame 1 receives the light and rechargeable engine battery 6. Speed control is obtained by controlling accelerator-variator 17 on the wheelchair handlebar. A brake handle activates two brakes 23.

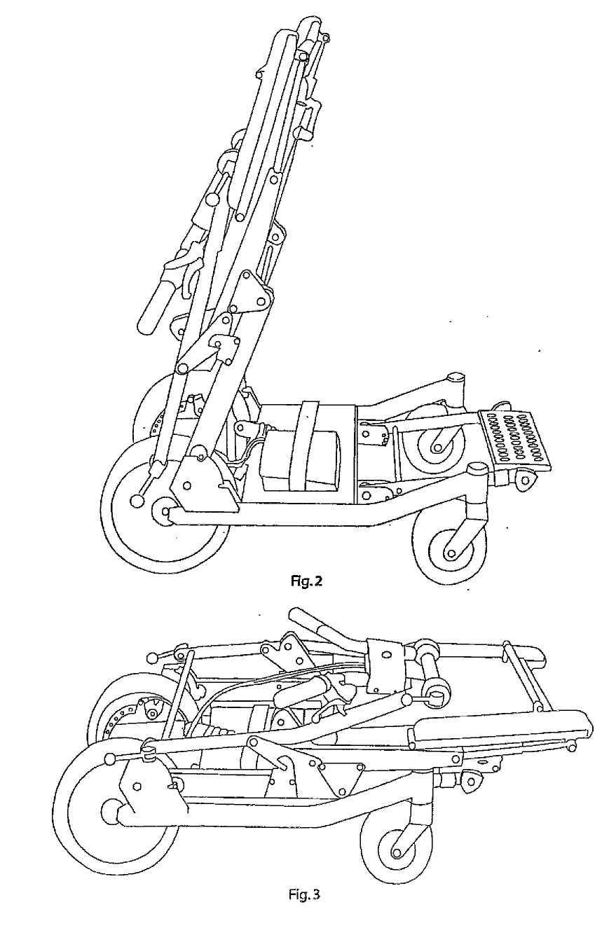

From the above description it can be easily perceived how the wheelchair shown in FIG. 1 can be folded, halfway as shown in FIG. 2, and fully folded, as shown in FIG. 3.

Within the context of this disclosure, numerous improvements can be contributed to this new wheelchair design, which are within the scope of the invention. The invention is to be limited only by the scope of the claims and reasonable equivalents thereof.

What is claimed is:

1. An electrical wheelchair that is completely foldable to be easily carried or stored, the wheelchair comprising:
an H-shaped chassis;
two oblique, articulated lift links are coupled to said chassis; and
two arms shaped and configured to allow the whole wheelchair to be easily and automatically folded.

2. The wheelchair according to claim 1, and further comprising:
a hinge bracket formed with a groove to receive an axis for automatic blocking in high position of said lift links, said two lift links support, on the one hand, a seat assembly that is shifted forward and, on the other hand, an adjustable back and two armrests; and
two cam locking systems having hook-shaped brackets, said arms and said locking systems being configured to lock said seat assembly in a horizontal position.

3. The wheelchair according to claim 1, wherein said H-shaped chassis supports on the rear a compact motor block for an oscillating motor coupled to driving wheels, the wheelchair is articulated and controlled by a shock absorber.

4. The wheelchair according to claim 2, wherein said H-shaped chassis supports on the rear a compact motor block for an oscillating motor coupled to driving wheels, the wheelchair is articulated and controlled by a shock absorber.

5. The wheelchair according to claim 1, and further comprising a height adjustable footrest on the front of said H-shaped chassis.

6. The wheelchair according to claim 2, and further comprising a height adjustable footrest on the front of said H-shaped chassis.

7. The wheelchair according to claim 3, and further comprising a height adjustable footrest on the front of said H-shaped chassis.

8. The wheelchair according to claim 1, and further comprising a battery support plate supported on said H-shaped chassis.

9. The wheelchair according to claim 2, and further comprising a battery support plate supported on said H-shaped chassis.

10. The wheelchair according to claim 3, and further comprising a battery support plate supported on said H-shaped chassis.

11. The wheelchair according to claim 4, and further comprising a battery support plate supported on said H-shaped chassis.

12. The wheelchair according to claim 5, and further comprising a battery support plate supported on said H-shaped chassis.

13. The wheelchair according to claim 6, and further comprising a battery support plate supported on said H-shaped chassis.

14. The wheelchair according to claim 7, and further comprising a battery support plate supported on said H-shaped chassis.
